(19) United States
(12) Patent Application Publication
(10) Pub. No.: US 2022/0356081 A1
(43) Pub. Date: Nov. 10, 2022

(54) ULTRASONIFICATION FOR BIOGAS

(71) Applicant: Breakthrough Technologies, LLC, Boston, MA (US)

(72) Inventor: Kamal Jaffrey, Winchester, MA (US)

(21) Appl. No.: 17/753,895

(22) PCT Filed: Sep. 18, 2020
(86) PCT No.: PCT/US20/51565

§ 371 Date: Mar. 17, 2022

Related U.S. Application Data
(60) Provisional application No. 62/903,590, filed on Sep. 20, 2019.

(51) Int. Cl. C02F 1/36

(52) U.S. Cl. CPC C02F 1/36; C02F 2103/32

(57) ABSTRACT

An ultrasonification system is provided. The ultrasonification system includes a duct having a proximal end and a distal end, and a vibrating head disposed within the duct near the proximal end thereof. A fluid enters the duct from the proximal end and flows toward the distal end. Related apparatus, systems, techniques, and articles are also described.

### RELATED APPLICATIONS

This application claims priority under 35 U.S.C. § 119 to U.S. provisional patent application No. 62/903,590 filed Sep. 20, 2019, the entire contents of which is hereby expressly incorporated by reference herein.

### TECHNICAL FIELD

The current subject matter relates to ultrasonification, for example, an ultrasonification system for biogas production with improved corrosion resistance and improved cavitation effects.

### BACKGROUND

Biogas is a byproduct from decomposition of organic matter by anaerobic or aerobic bacteria, and primarily includes methane (CH₄), carbon dioxide (CO₂), and hydrogen sulfide (HS). Biogas is considered a renewable fuel, which can be used as an alternative for fossil fuels. Biogas is produced from organic waste sources such as municipal waste, sewage sludge, manure, byproduct stream from sugar refineries, and the like, which are generated during the waste stream treatment in a fermenter or digester. To enhance disintegration of the biomass and increase microbiological activities in the fermenter, an ultrasonification (e.g., ultrasonic treatment or ultrasonication) is used. The disintegration of the biomass by ultrasonification breaks up biomass by means of ultrasound using the pressure fluctuations caused by the ultrasound cavitation. The use of ultrasound cavitation also decreases the viscosity of the biomass suspension, and is a more power efficient method than stirring or pumping processes for biogas plants.

### SUMMARY

An aspect of the present disclosure provides a system for ultrasonification. The system may include a duct including a proximal end and a distal end, and a vibrating head disposed within the duct near the proximal end thereof. A fluid may enter the duct from the proximal end and flows toward the distal end.

One or more of the following features can be included in any feasible combination. For example, the duct may include a contraction section at downstream of the vibrating head. The system may include a sonotrode to oscillate the vibrating head ultrasonically. The sonotrode may oscillate the vibrating head at frequencies between about 20 kHz and about 70 kHz, inclusive, and amplitudes between about 10 μm to about 150 μm, inclusive. The fluid may enter the duct from the proximal end, pass around the vibrating head, and accelerate through the contraction section. The duct may include an expansion section disposed adjacent to the contraction section at downstream thereof. The fluid may include at least one of municipal waste, sewage sludge, manure, crude oil, or a spent wash from a sugar refinery.

In another aspect, a method of ultrasonification may include supplying a fluid through a duct from a proximal end toward a distal end, and oscillating the fluid with a vibrating head. The vibrating head may be disposed within the duct near the proximal end thereof.

One or more of the following features can be included in any feasible combination. For example, the method may include causing a pressure of the fluid to decrease by providing a contraction section in the duct. A plurality of cavitation bubbles may be generated due to the oscillation of the vibrating head, and a number of the plurality of cavitation bubbles may be increased as the pressure of the fluid is decreased. The fluid may be choked at the contraction section of the duct. The pressure may be decreased below a saturation pressure of the fluid at the contraction section of the duct. The method may include causing the pressure of the fluid to increase by providing an expansion section disposed adjacent to the contraction section at downstream thereof. The vibration head may be oscillated ultrasonically by a sonotrode. The sonotrode may oscillate the vibrating head at frequencies between about 20 kHz and about 70 kHz, inclusive, and amplitudes between about 10 μm to about 150 μm, inclusive. The fluid may include at least one of municipal waste, sewage sludge, manure, crude oil, or a spent wash from a sugar refinery.

The details of one or more variations of the subject matter described herein are set forth in the accompanying drawings and the description below. Other features and advantages of the subject matter described herein will be apparent from the description and drawings, and from the claims.

### BRIEF DESCRIPTION OF DRAWINGS

A brief description of each drawing is provided to more sufficiently understand drawings used in the detailed description of the present disclosure.

FIG. 1 is a schematic view of an ultrasonification system according to the related art;

FIG. 2 is a schematic view of an ultrasonification system according to an exemplary embodiment of the present disclosure;

FIG. 3 schematically shows the formation of cavitation within the contraction section of the duct in the ultrasonification system according to an exemplary embodiment of the present disclosure;

FIG. 4 schematically describes a controlled flow cavitation that occurs within the contraction section of the duct in the ultrasonification system according to an exemplary embodiment of the present disclosure;

FIG. 5 schematically illustrates boundary layer formation and development through a contracting-expanding duct in the ultrasonification system according to an exemplary embodiment of the present disclosure;

FIGS. 6A-6E show various configurations for integrating the ultrasonification system according to the present disclosure with a bio reactor;

FIG. 7 illustrates contour pressure of an example implementation of an ultrasonification system;

FIG. 8 illustrates multislice velocity magnitude in meters per second (m/s) of the example implementation of the ultrasonification system;

FIG. 9 illustrates volume velocity magnitude in meters per second (m/s) of the example implementation of the ultrasonification system;

FIG. 10 illustrates arrow volume velocity field of the example implementation of the ultrasonification system;

FIG. 11 illustrates contour velocity magnitude in meters per second (m/s) of the example implementation of the ultrasonification system;

FIG. 12 illustrates a perspective view of an example implementation of the ultrasonification system; and

FIG. 13 illustrates a side view of a portion of another example implementation of the ultrasonification system.

It should be understood that the above-referenced drawings are not necessarily to scale, presenting a somewhat simplified representation of various features illustrative of the basic principles of the disclosure. The specific design features of the present disclosure, including, for example, specific dimensions, orientations, locations, and shapes, will be determined in part by the particular intended application and use environment.

### DETAILED DESCRIPTION

The current subject matter provides an ultrasonification system, for example, ultrasonification system for biogas production that can enhance the generation of cavitation and can provide improved corrosion resistance. Due to the enhanced cavitation, some implementations of the ultrasonification system according to the present disclosure may treat fluids, sludges, or any materials that are high in biomaterials, or any substance that is high in chemical oxygen demand (COD) or biological oxygen demand (BOD). In addition, some implementations of the ultrasonification system can treat fluids or sludges having higher viscosities, such as fat, oil, and grease, which can be difficult to treat with conventional ultrasound technologies. The enhanced cavitation may increase the biogas production rates, and also may improve the quality of spent wash. Furthermore, some implementations of the ultrasonification system according to the present disclosure may provide an improved resistance against corrosion, such as “pitting corrosion,” which is a form of localized corrosion that leads to the creation of small voids in a metal surface. The current subject matter can enable degassing of liquids.

The ultrasonification system according to the present disclosure may be applied in a fermenter or digester to more efficiently produce biogas. Biogas is a byproduct of the decomposition of organic matter by anaerobic or aerobic bacteria, and it primarily comprises methane (CH₄), carbon dioxide (CO₂), and hydrogen sulfide (HS). A biogas plant produces biogas from organic waste sources, such as municipal waste, sewage sludge, manure, byproduct stream from sugar refineries, and the like. For example, byproducts of a sugar refinery may be fermented to produce biogas. The ultrasonification of the organic material before or during the microbial digestion may improve the biogas production, and may reduce the amount of residual sludge to be disposed. Since aggregates and cellular structures in the biomass sludge may be destructed due to ultrasonification, the sludge may be dewatered more efficiently. Further, the destruction of the aggregates and cell walls may allow the bacteria to more easily access intracellular material for decomposition.

The ultrasonification techniques may sonicate liquid at high intensities, and the sound waves that propagate within the liquid media may result in alternating high pressure (compression) and low-pressure (rarefaction) cycles. During the low-pressure cycle, the ultrasonic waves may create small vacuum bubbles within the liquid. When the bubbles grow and reach a critical volume, they may collapse or burst during the high-pressure cycle. This phenomenon is referred to as cavitation. During the implosion, local temperatures of approximately 5,000 K and local pressures of approximately 2,000 atm may be reached. In some implementations, water splitting (e.g., production of oxygen and hydrogen) can occur during this process. Water splitting can change the pH of the fluid.

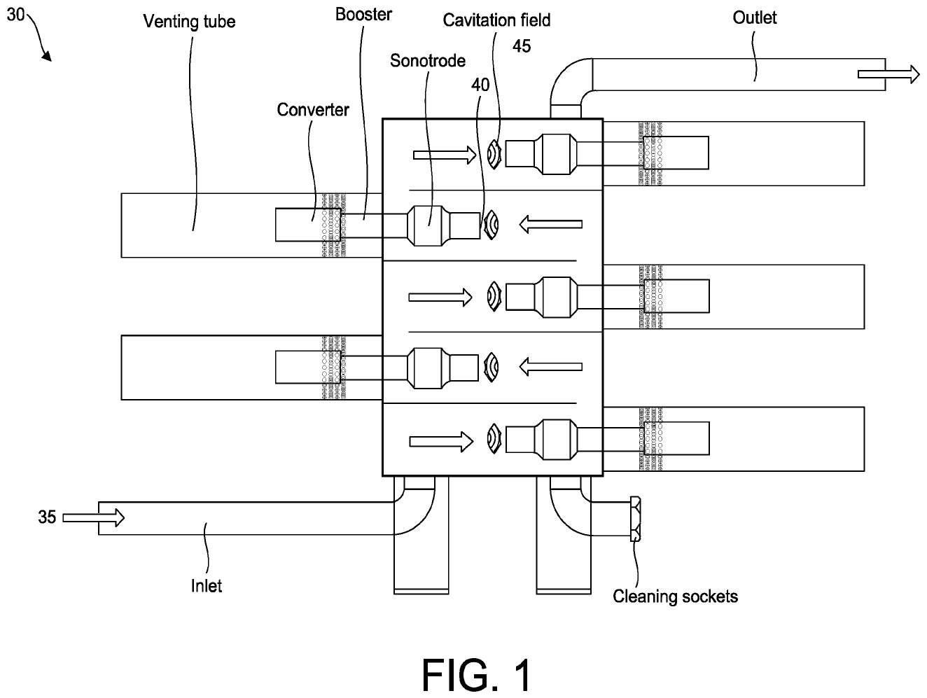

However, in the ultrasonification systems of the related art, due to the local high pressure and/or temperature as well as the corrosive nature of cavitation, a vibrating head (e.g., piston) and an interior surface of the ultrasonification system may be corroded. As shown in FIG. 1, in the ultrasonification systems 30 of the related art, fluid flow 35 is introduced toward the vibrating head 40, and therefore the cavitation field 45 is formed in front (e.g., upstream) of the vibrating head 40. Due to this flow configuration, the cavitation bubbles directly attack the vibrating head 40, and the corrosion problem becomes aggravated. Moreover, in the ultrasonification systems 30 of the related art, the boundary layer of the fluid is constantly disturbed by the ultrasonification, and the interior walls of the system 30 is exposed to the cavitation bubbles. Accordingly, the interior walls of the conventional ultrasonification system 30 is more susceptible to corrosion.

Aspects of the present disclosure provide an ultrasonification system and a method of ultrasonification that may improve the corrosion resistance and the biogas production efficiency. In the ultrasonification system according to the present disclosure, the fluid flow may be introduced from a side proximate to the vibrating head, and the fluid may flow away from the vibrating head. Because this flow configuration, since the cavitation field is formed at the downstream of the vibrating head, the cavitation bubbles may be prevented from directly attacking the vibrating head of the system, and the corrosion problem may be mitigated. Further, the boundary layer of the fluid may be maintained more stably, compared to the counter-flow configuration in the ultrasonification systems of the related art, and the interior walls of the system may be better protected from the corrosion.

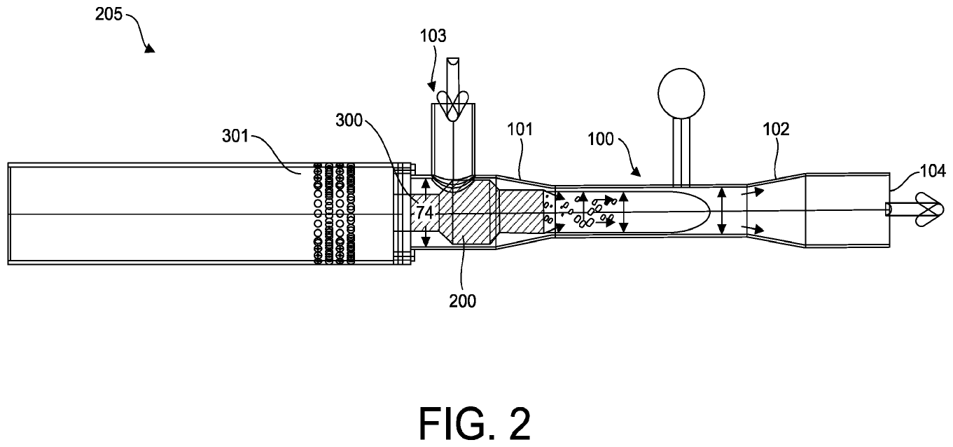

An aspect of the present disclosure provides an ultrasonification system for biogas production. FIG. 2 schematically illustrates the ultrasonification system 205 according to an exemplary embodiment of the present disclosure. Referring to FIG. 2, the ultrasonification system 205 may include a duct 100, which includes a proximal end and a distal end. The ultrasonification system may also include a vibrating head 200 that is disposed within the duct 100. The vibrating head 200 may be disposed near the proximal end of the duct 100, and accordingly, a fluid may enter the duct 100 from the proximal end of the duct 100 and may flow away from the vibrating head 200 toward the distal end of the duct 100. Fluid flow is illustrated flowing from inlet 103 to outlet 104.

In some embodiments, the vibrating head 200 may be oscillated using a sonotrode 300. The sonotrode 300 is an apparatus that may create ultrasonic vibrations and apply the vibrational energy to a working fluid. The sonotrode 300 may be oscillated using a piezoelectric transducer by applying an alternating current that oscillates at ultrasonic frequencies. The applied alternating current may cause the piezoelectric transducer to continually expand and contract to create the ultrasonic vibration of the connected vibrating head 200. For example, the sonotrode 300 may generate ultrasonic frequencies of about 20 kHz to about 70 kHz, and vibration amplitudes of about 10 μm to about 150 μm. The sonotrode 300 may further include a venting tube 301 to attenuate the noise.

In the ultrasonification system according to an exemplary embodiment of the present disclosure, due to the flow configuration in which the fluid moves away from the vibrating head 200, a cavitation field may be formed at the downstream of the vibrating head 200, and accordingly, the vibrating head 200 may be better protected from corrosion due the cavitation.

Additionally or alternatively, the duct 100 of the ultrasonification system may include a contraction section 101 at the downstream of the vibrating head 200. For example, the fluid may enter the duct 100 from the proximal end, pass around the vibrating head 200, and accelerate through the contraction section 101. The working fluid may be accelerated in the contraction section 101 of the duct 100, and accordingly, the pressure of the fluid may be decreased due to the Venturi effect. The Venturi effect may refer to a fluid dynamic effect where a velocity of the fluid is increased and a static pressure of the fluid is decreased as the fluid passes through a contraction section of a duct due to the smaller cross-sectional area at the contraction section. In the ultrasonification system according to an exemplary embodiment of the present disclosure, the reduced pressure at the contraction section 101 may enhance the cavitation. In some embodiments, the contraction section 101 may be followed by an expansion section 102 to recover the pressure. This structure can change the near and far field effect of the ultrasonification. In some implementations, the contraction section 101 can enable dispersion of the air bubbles. In some implementations, the length of the constriction portion can vary, which can account for different (e.g., lower or higher) flow rates. A longer constriction portion can account for a higher flow rate.

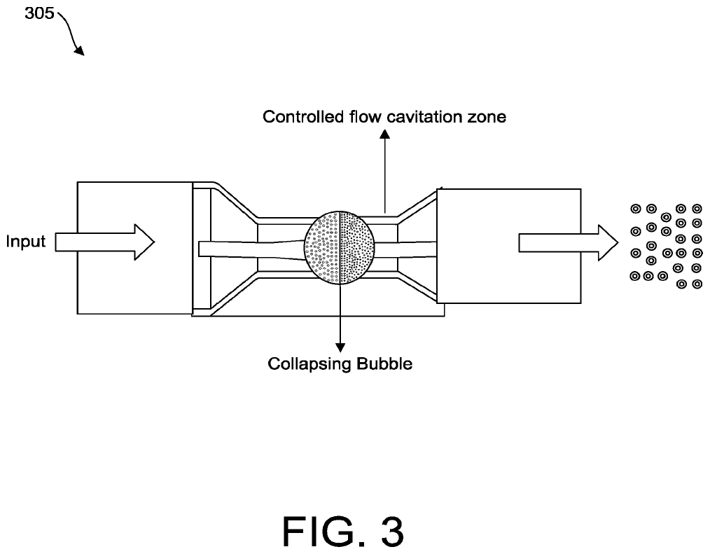

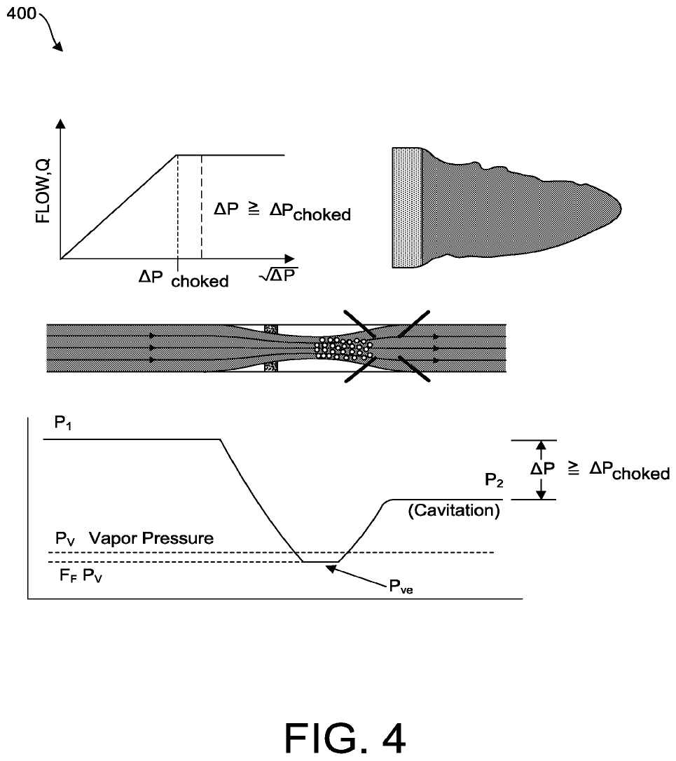

FIG. 3 schematically illustrates at 305 the cavitation formation at the contraction section of the duct. A cross-sectional area of the contraction section may be designed to choke the fluid flow to enhance the cavitation. FIG. 4 describes, at 400, the physical mechanism of the cavitation enhancement due to the choked flow. As the fluid enters the contraction section of the duct, the pressure starts to drop. When the pressure drops below a saturation vapor pressure of the fluid at the instant temperature, the fluid may experience a phase change and be vaporized. Subsequently, in the expansion section of the duct, the pressure is increased as the fluid velocity is decreased. As such, the pressure fluctuation below and above the saturation vapor pressure, causes the cavitation bubbles to be formed and/or a number of existing cavitation bubbles to be increased, thereby enhancing the cavitation effects of the vibrating head. The cavitation process using the contracting-expanding duct may be referred to as a “controlled flow cavitation.”

In the ultrasonification system according to an exemplary embodiment of the present disclosure, the enhanced cavitation due to the controlled flow cavitation may increase the microbial activities within the fermenter of the biogas reactor, increase the biogas production efficiencies, and improve the quality of the spent wash. For example, using the ultrasonification system according to the present disclosure, the biogas production may be increased by 30% or more, and the chemical oxygen demand (COD) of the sludge may be decreased below 20,000 parts-per-million (ppm).

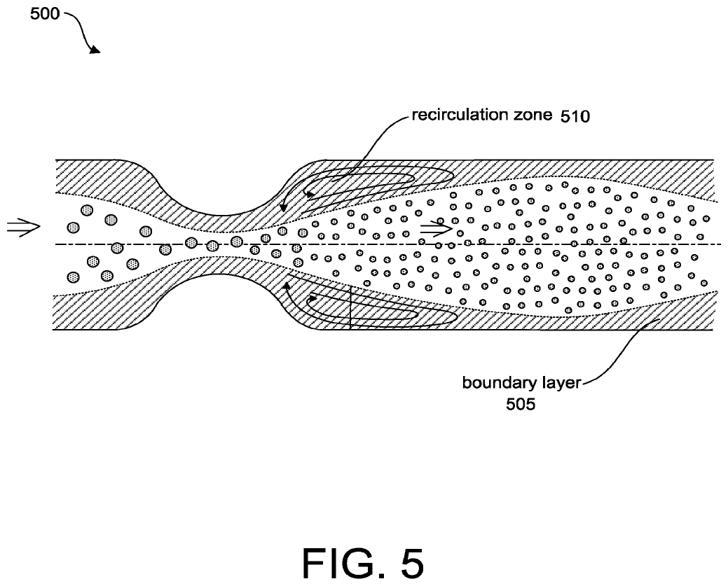

FIG. 5 schematically illustrates, at 500, boundary layer 505 formation and development within a contracting-expanding duct. Recirculation zone 510 is also illustrated. Unlike the ultrasonification systems of the related art, where the boundary layer of the fluid flow is constantly disturbed and broken by the on-coming sound waves, the ultrasonification system according to the present disclosure may form and develop the boundary layer 505. As shown in FIG. 5, since the boundary layer 505 may be more stably maintained within the duct of the ultrasonification system, a momentum exchange across the boundary layer 505 becomes reduced or prevented, and the cavitation bubbles may be prevented from reaching the interior walls of the duct. Accordingly, the ultrasonification system of the present disclosure may provide improved corrosion resistance.

Another aspect of the present disclosure provides a method of creating cavitation in biomass sludge using an ultrasonification system. The method may include supplying a fluid through a duct to allow the fluid to flow from a proximal end of the duct toward a distal end of the duct. A vibrating head may be disposed within the duct near the proximal end thereof, and the fluid may be ultrasonically oscillated with the vibrating head. Due to the flow configuration in which the fluid moves away from the vibrating head, a cavitation field may be formed at the downstream of the vibrating head, and accordingly, the vibrating head may be better protected from the corrosion due to the cavitation. The vibration head may be oscillated ultrasonically by a sonotrode. For example, the sonotrode may oscillate the vibration head at frequencies of about 20 kHz to about 70 kHz and amplitudes of about 10 μm to about 150 μm.

Alternatively or additionally, to enhance the cavitation, a pressure of the fluid may be decreased within the duct. For example, the pressure of the fluid may be decreased by providing a contraction section within the duct. When the contraction section is provided within the duct and decreases the pressure of the fluid, a plurality of cavitation bubbles may be generated due to the ultrasonic oscillation of the vibrating head, and a number of the plurality of cavitation bubbles may be increased as the pressure of the fluid is decreased. In some implementations, the contraction section of the duct may be designed to choke the fluid flow. In some embodiments, the pressure of the fluid may be increased after the contraction section by providing an expansion section disposed adjacent to the contraction section at the downstream thereof.

In some embodiments, the pressure may be decreased, at the contraction section of the duct, below the saturation pressure of the fluid. Subsequently, the pressure may be increased again, at the expansion section of the duct, above the saturation pressure of the fluid.

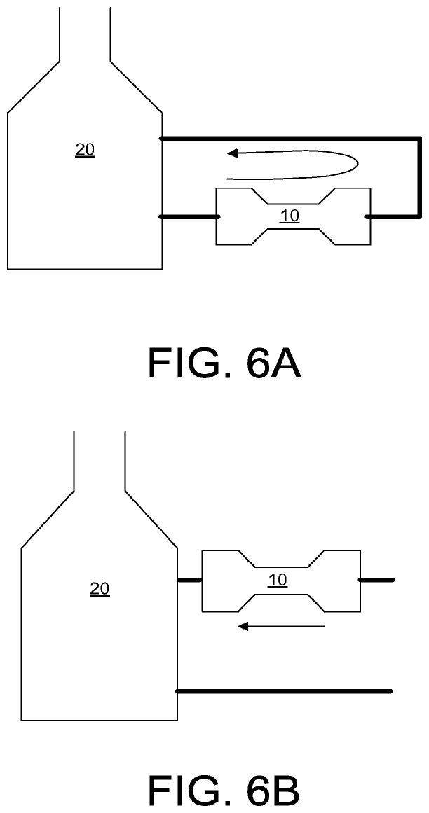

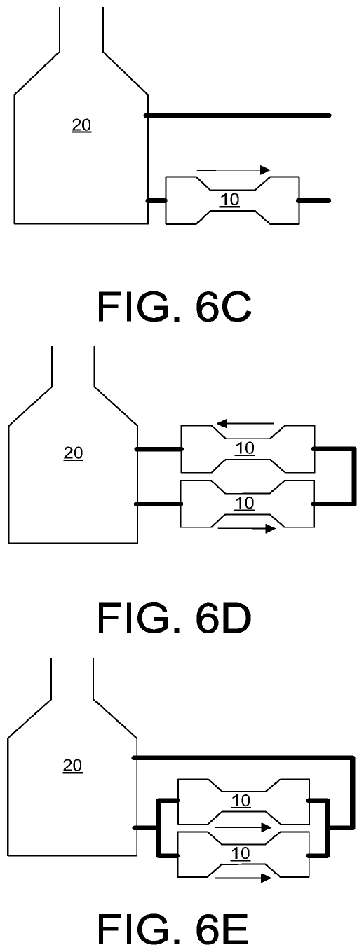

As shown in FIGS. 6A-6C, the ultrasonification system according to the present disclosure may be integrated with bio reactors for biogas production in various configurations. Referring to FIG. 6A, the ultrasonification system 10 may be configured to take an input stream from the bio reactor 20 (e.g., fermenter), ultrasonically treat the fluid within the ultrasonification system 10, and return the treated stream to the bio reactor 20, thereby forming a closed loop configuration. Alternatively, referring to FIG. 6B, the ultrasonification system 10 may be configured to ultrasonically process the fluid prior to entering the bio reactor 20. The closed-loop configuration and the pre-treatment configuration may be used for sludge treatment. Alternatively or additionally, the ultrasonification system may be used for treating the wastewater that is discharged from the bio reactor. In this case, the ultrasonification system 10 may be connected to the bio reactor 20 at the downstream thereof, as shown in FIG. 6C. However, the integration of the ultrasonification systems with the bio reactor is not limited to these configurations, and the configuration may be varied based on system requirements, system loading, and the type of working fluid. Furthermore, more than one ultrasonification system may be connected in series and/or in parallel as shown in FIGS. 6D and 6E.

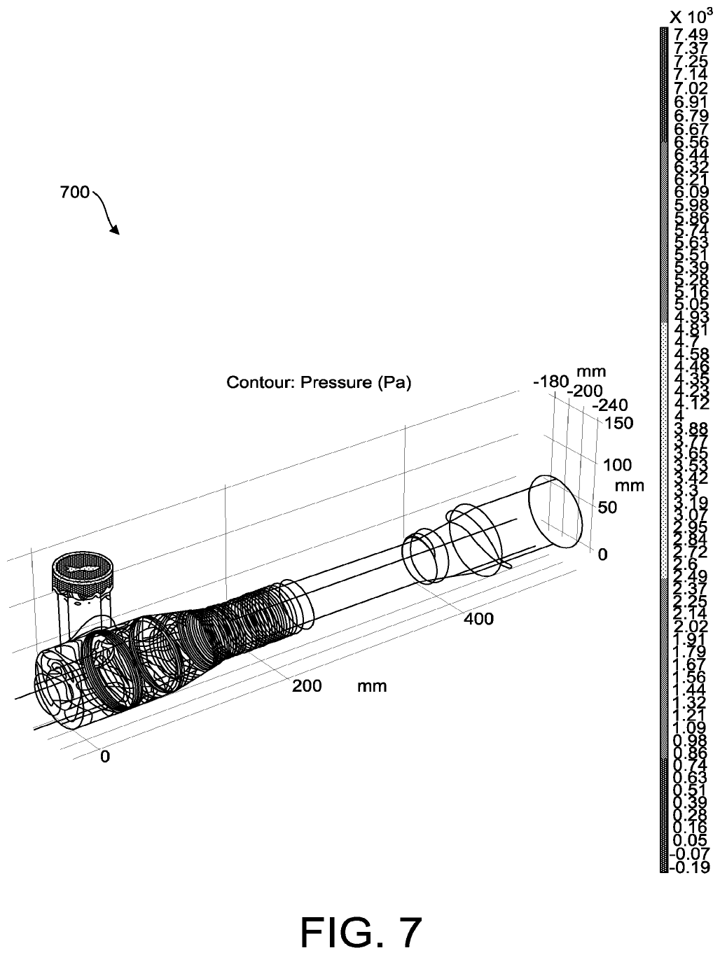

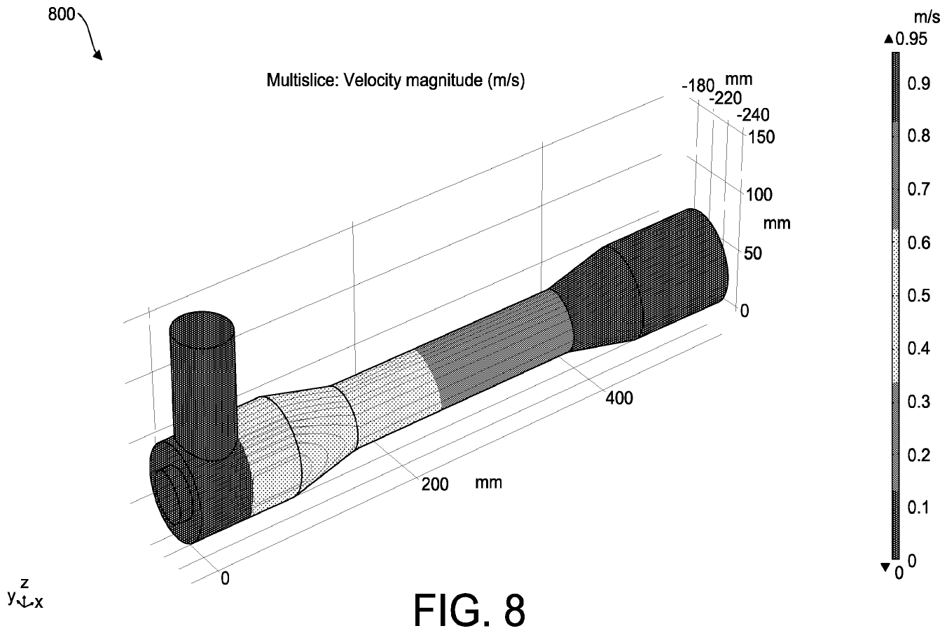

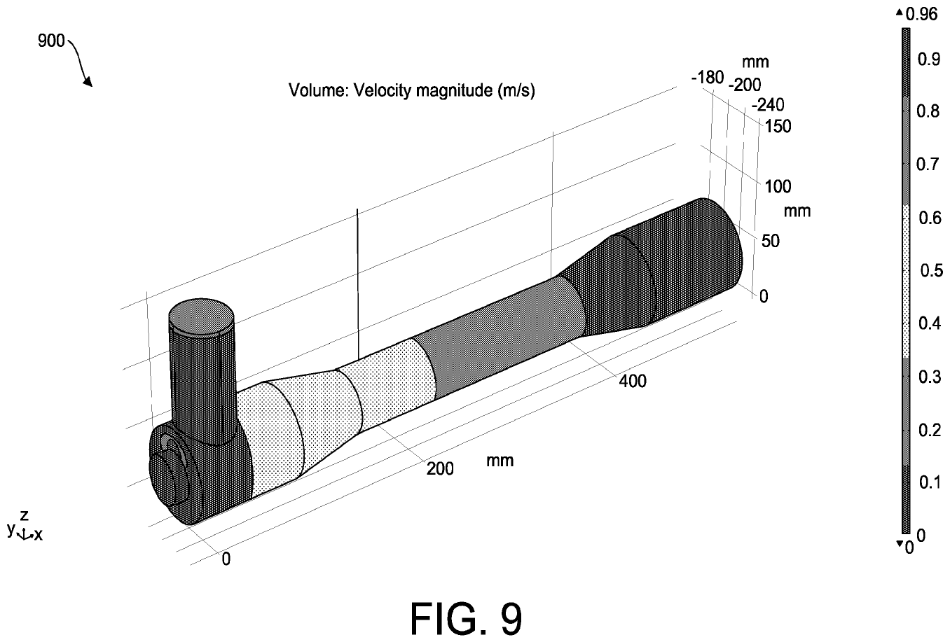

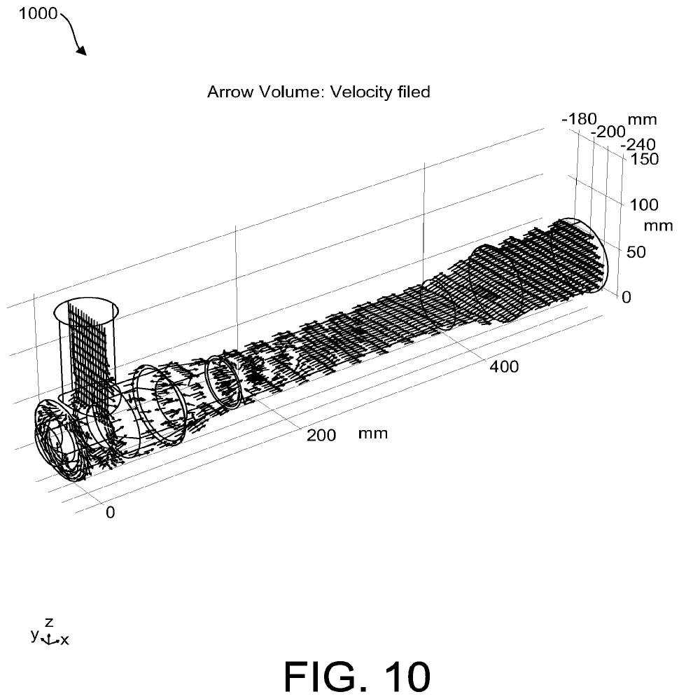

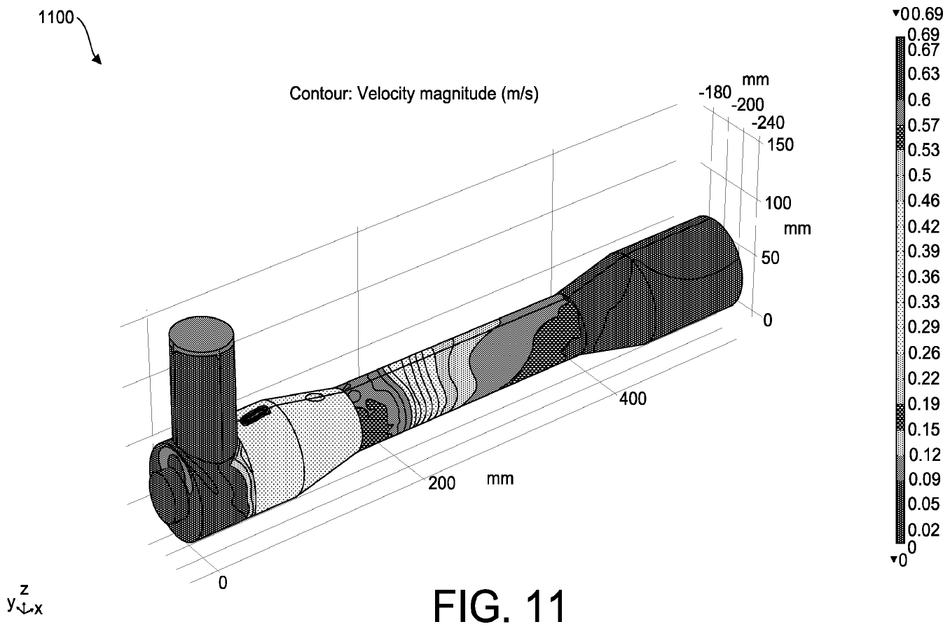

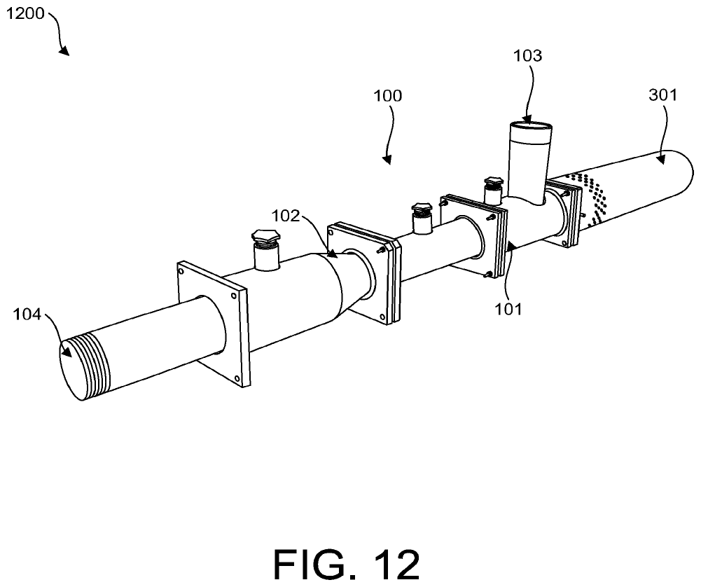

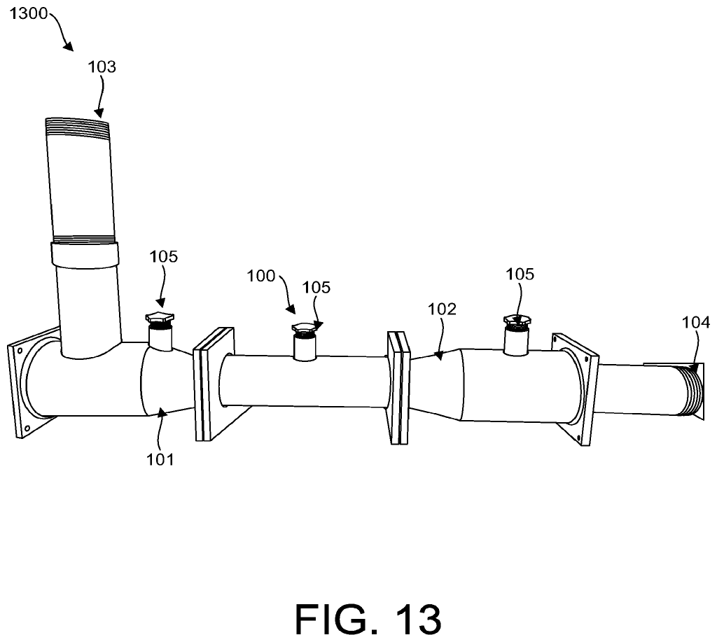

FIG. 7 illustrates contour pressure 700 of an example implementation of an ultrasonification system. FIG. 8 illustrates multislice velocity magnitude 800 in meters per second (m/s) of the example implementation of the ultrasonification system. FIG. 9 illustrates volume velocity magnitude 900 in meters per second (m/s) of the example implementation of the ultrasonification system. FIG. 10 illustrates arrow volume velocity field 1000 of the example implementation of the ultrasonification system. FIG. 11 illustrates contour velocity magnitude 1100 in meters per second (m/s) of the example implementation of the ultrasonification system. FIG. 12 illustrates a perspective view 1200 of an example implementation of the ultrasonification system and FIG. 13 illustrates a side view 1300 of a portion of another example implementation of the ultrasonification system.

The subject matter described herein may provide many technical advantages. For example, the ultrasonification system according to the present disclosure may treat fluids or sludges with higher viscosity, such as fat, oil, and grease, which can be difficult to treat with conventional ultrasound technologies. Due to the enhanced cavitation using a controlled flow cavitation, the ultrasonification system according to the present disclosure may increase the microbial activities in the bio reactor and increase the production of the biogas. Furthermore, due to the flow configuration in which the fluid flow enters the duct from the sonotrode side and flows away therefrom, the ultrasonification system according to the present disclosure may provide improved corrosion resistance.

In some implementations, the system can be self-cleaning (e.g., does not require cleaning ports as in the related art). In addition, in some implementations, the Venturi effect can be achieved by circular cross section of reactor (e.g., tube) versus a rectangular cross section. In some implementations of the current subject matter, only a single sonotrode is utilized, which can be advantageous in that the single sonotrode does not need to be synchronized with other sonotrodes in the system, the single sonotrode may achieve similar effect to multiple sonotrodes (e.g., fewer sonotrodes are required making the system cheaper and more efficient). In some implementations of the current subject matter, abrasion (e.g., pitting) of sonotrodes that causes metal to enter stream can be avoided and/or reduced, thus reducing the amount of metal entering the stream. In some implementations, only having a single sonotrode can keep fluid temperature low because the sonotrode can introduce heat into the fluid, and by having fewer sonotrodes, less heat is introduced into the fluid.

The current subject matter is not limited to treatment of spent wash but can apply in other applications of separating materials from liquid. For example, the current subject matter can be applied for oil processing to remove sulfur from crude oil. For example, because the cavitation creates high temperature and pressures, chemical bonds can be broken to separate certain materials such as heavy metals. In some implementations, the current subject can be applied to any colloidal mixtures. In some implementations, the ultrasonification device can be utilized for processing a ballast tank of a ship to empty the ballast tank. For example, ships can include ballast tanks that are filled with water (either fresh water or salt water), which can become contaminated over time. An ultrasonification device according to the current subject matter can be applied to treat this water prior to or during emptying of the ballast tank. As another example, the current subject matter can be utilized as a sono-chemical processor that can be utilized for mixing difficult-to-mix fluids.

In some implementations, sensors can be included at different locations within the device. For example, ports 105 illustrated in FIG. 13 can house sensors such as temperature sensor, pressure sensor, and/or an ultrasonic wave sensor (e.g., an ultrasound receiver). Measurements from these sensors can be used to determine viscosity, density, CoD content, and the like. Determining CoD is possible because the CoD content affects the speed of ultrasound wave propagation (which can be measured via the ultrasound receiver) and therefore the speed of propagation can be determined and correlated to CoD content.

In some implementations, the viscosity or density of the fluid can be controlled to ensure an appropriate viscosity for use by the ultrasonification device. For example, the sensor measurements can be processed by a data processor and form part of a feedback loop to control flow rate, e.g., via a macerator pump. Flow rate can be controlled based on viscosity, for example, an increase in viscosity can result in controlling the macerator pump to increase the maceration, thereby reducing the viscosity. Other feedback parameters are possible. For example, temperature can be controlled via changing a frequency of the sonotrode and vibrating head.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A system comprising:
a duct including a proximal end and a distal end; and
a vibrating head disposed within the duct near the proximal end thereof,
wherein the system is configured to allow a fluid to enter the duct from the proximal end and flow toward the distal end.

2. The system of claim 1, wherein the duct includes a contraction section at downstream of the vibrating head.

3. The system of claim 1, further comprising a sonotrode to oscillate the vibrating head ultrasonically.

4. The system of claim 3, wherein the sonotrode oscillates the vibrating head at frequencies between about 20 kHz and about 70 kHz, inclusive, and amplitudes between about 10 μm to about 150 μm, inclusive.

5. The system of claim 2, wherein the system is configured to allow the fluid to enter the duct from the proximal end, pass around the vibrating head, and accelerate through the contraction section.

6. The system of claim 2, wherein the duct further includes an expansion section disposed adjacent to the contraction section at downstream thereof.

7. The system of claim 1, wherein the fluid includes at least one selected from a group consisting of municipal waste, sewage sludge, manure, crude oil, and a spent wash from a sugar refinery.

8. A method comprising:
supplying a fluid through a duct from a proximal end toward a distal end; and
oscillating the fluid with a vibrating head,
wherein the vibrating head is disposed within the duct near the proximal end thereof.

9. The method of claim 8, further comprising:
causing a pressure of the fluid to decrease by providing a contraction section in the duct.

10. The method of claim 9, wherein a plurality of cavitation bubbles are generated due to the oscillation of the vibrating head, and
wherein a number of the plurality of cavitation bubbles is increased as the pressure of the fluid is decreased.

11. The method of claim 9, wherein the fluid is choked at the contraction section of the duct.

12. The method of claim 9, wherein the pressure is decreased below a saturation pressure of the fluid at the contraction section of the duct.

13. The method of claim 9, further comprising:
causing the pressure of the fluid to increase by providing an expansion section disposed adjacent to the contraction section at downstream thereof.

14. The method of claim 8, wherein the vibration head is oscillated ultrasonically by a sonotrode.

15. The method of claim 14, wherein the sonotrode oscillates the vibrating head at frequencies between about 20 kHz and about 70 kHz, inclusive, and amplitudes between about 10 μm to about 150 μm, inclusive.

16. The method of claim 8, wherein the fluid includes at least one selected from a group consisting of municipal waste, sewage sludge, manure, crude oil, and a spent wash from a sugar refinery.

17. Apparatus, systems, articles, and techniques described and/or illustrated herein.
